(19) United States
(12) Patent Application Publication
(10) Pub. No.: US 2003/0091956 A1
(43) Pub. Date: May 15, 2003

(54) Dental instrument

(76) Inventors: Richard Graham Chadwick, Dundee (GB); Charles Proctor Gibson, Dundee (GB)

Correspondence Address: MYERS BIGEL SIBLEY & SAJOVEC, PO BOX 37428, RALEIGH, NC, 27627, US

(21) Appl. No.: 10/070,838

(22) PCT Filed: Dec. 7, 2000
(86) PCT No.: PCT/GB00/04666

(30) Foreign Application Priority Data
Dec. 9, 1999 (GB) 9929007.4

(51) Int. Cl. A61C 3/00; A61C 19/04

(52) U.S. Cl. 433/31; 433/72; 433/102

(57) ABSTRACT

The invention relates to a dental instrument, in particular a dentist's hand tool for precisely determining and setting the lengths of dental cutting tools.

In one embodiment, a dentist's hand tool (10) is disclosed, having a mirror portion (12) and a handle (13). The handle (13) incorporates a well or socket (48) at its end remote from the mirror portion (12), which includes a threaded sleeve (18) which engages a threaded rod (14) of the handle (13). The length or depth of the well or socket (48) is adjusted by rotating the sleeve (18) until the well (48) is set at a desired depth, measured between an end face (31) of the rod (14) and an end (41) of the sleeve (18) using scales (28,44). A dental tool (50) then inserted into the well (48) can be set to a predetermined depth of operation and a depth stop (54) on the tool (50) adjusted to set this depth.

The present invention relates to a dental instrument. In particular, the present invention relates to a dentist's hand tool for precisely determining and setting the lengths of dental cutting tools.

When performing dental operations such as preparing the root canals of endodontically involved teeth using dental cutting tools such as files and reamers, it is important to control the depth of penetration of the cutting tool to avoid injury. It is for this reason that such cutting tools include adjustable depth stops. During the preparation of root canals in such an operation, a dentist may make use of many such files or reamers of different diameters, and interruptions to the operation are frequent as the dentist is required to cease operating in order to measure and adjust (if necessary) the position of the depth stop on each new file or reamer being used. This is both a time consuming and involved process.

Attempts to speed this process up have been made by, for example, providing a typical dental mirror with a flat, recessed, graduated scale on the handle of the mirror, against which the lengths of cutting tools such as files or reamers may be measured. Such a dental mirror is disclosed in U.S. Pat. No. 4,252,522. However, use of the mirror of U.S. Pat. No. 4,252,522 involves awkward and imprecise alignment of the file or reamer to the scale and lacks automatic adjustment of the tool depth stop. Thus there is still a loss of time during performance of the operation and scope for inaccuracy in the determination of the length of the file or reamer.

It is amongst the objects of the present invention to obviate or mitigate one or more of the foregoing disadvantages.

Accordingly, the present invention provides a dental instrument in the form of a dentist's hand tool having a well or socket of adjustable depth, the width of the well or socket being sufficient to receive a dental cutting tool the length of which is to be determined and set according to the depth of the well or socket.

Preferably the dentist's hand tool is a mirror.

Preferably the well or socket is formed in a handle of the hand tool.

Preferably the handle comprises a rod which is engaged by one end of an elongated sleeve and the well or socket is formed between the end of the rod within the sleeve and the other, open, end of the sleeve.

Thus the sleeve has an end which is intended to abut an adjustable depth stop on the cutting tool, this enabling the depth stop to be set to define a determined length of the cutting tool when the end of the cutting tool abuts the end of the rod in the well.

The sleeve may engage the rod via a screw thread arrangement, such that the sleeve may rotate around the rod and may move axially with respect to the rod.

Alternatively, the sleeve engages the rod via a friction fit such that the sleeve engages the rod in a sliding engagement.

In a further alternative, the sleeve engages the rod in a latching arrangement such that the sleeve has a number of predetermined latching positions on the rod.

Preferably the hand tool further comprises locking means for locking the sleeve in a desired axial position with respect to the rod.

The locking means may be a collar which engages the rod and abuts the sleeve to prevent the sleeve from advancing further over the rod.

The end of the rod may have a shallow recess which locates the end of the cutting tool during determination and setting of its length.

Preferably the sleeve has a graduated scale for determining the length of the dental cutting tool inserted in the well and a window through which the cutting tool may be viewed.

The scale may be provided upon an external surface of the sleeve where it is visible by a user.

The outer surface of the rod visible in the well when the sleeve engages the rod may have a Vernier scale thereon to facilitate precise determination of the length of the cutting tool.

Embodiments of the invention will now be described, by way of example, with reference to the accompanying drawings, of which:

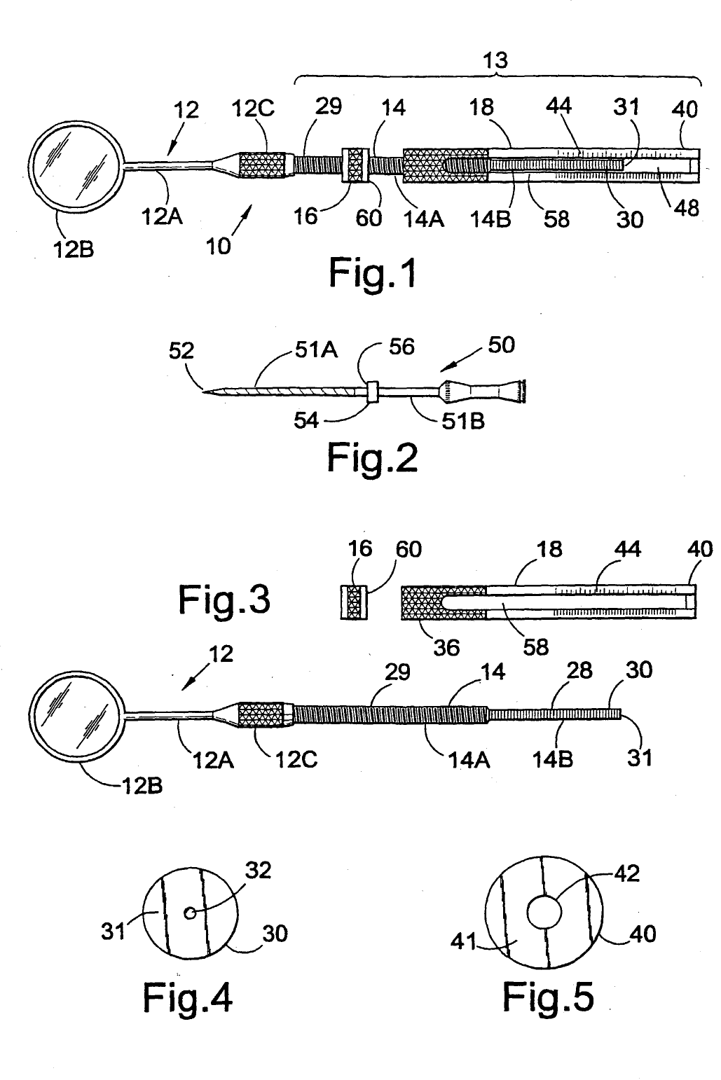

FIG. 1 is a view of a dental mirror in accordance with an embodiment of the present invention;

FIG. 2 is a view of a dental file;

FIG. 3 is a view of the dental mirror of FIG. 1 showing all of the component parts of the mirror in a disassembled state;

FIG. 4 is an end view of a sleeve of the dental mirror of FIG. 1;

FIG. 5 is an end view of a threaded rod of the dental mirror of FIG. 1;

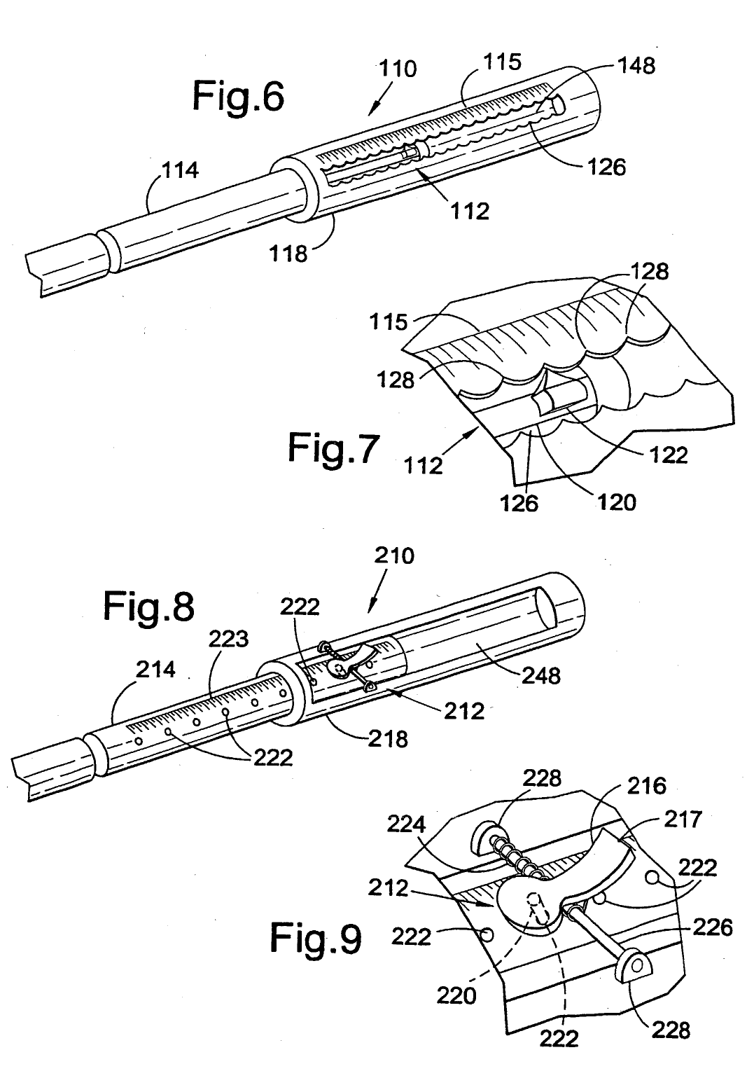

FIG. 6 is a perspective view of part of a dental mirror in accordance with an alternative embodiment of the present invention;

FIG. 7 is an enlarged view of part of the dental mirror of FIG. 6;

FIG. 8 is a perspective view of part of a dental mirror in accordance with a further alternative embodiment of the present invention; and FIG. 9 is an enlarged view of part of the dental mirror of FIG. 8.

Referring firstly to FIG. 1, there is shown a dentist's hand tool 10 for precisely determining and setting the lengths of dental cutting tools.

Tool 10 comprises a mirror portion 12 releasably secured to a handle 13. Mirror portion 12 comprises a stalk 12A, a mirror 12B and barrel 12C which is externally knurled so as to form a finger grip. The interior of the barrel 12C is threaded and receives one end 29 of a threaded rod 14 forming part of the handle 13.

The handle 13 incorporates a well or socket 48 at its end remote from the mirror portion 12, by means of an elongated sleeve 18 which at one end 36 engages the threaded rod 14. The well or socket 48 is formed between the end 30 of rod 14 within the sleeve 18 and the exposed free end 40 of the sleeve itself. The sleeve 18 has a bore size which defines the width of the well 48 and which is sufficient to receive a dental cutting tool, the length of which is to be determined and set by the length or depth of the well or socket 48.

FIG. 2 illustrates a typical dental cutting tool 50. Tool 50 has a file or reamer portion 51A formed at the end of a rod 51B which carries a rubber depth stop 54. Portion 51A is externally threaded to facilitate the cutting action of tool 50. Depth stop 54 is slidable over rod 51B and presents an annular face 56 which functions as an abutment surface to limit penetration of portion 51A into a dental cavity. The distance between face 56 and point 52 of portion 51A is therefore preset by the dental operator. Generally, this is achieved by inserting portion 51A into the well or socket 48 of the tool 10 until such time as point 52 engages the floor of the well or socket and thereafter sliding stop 54 until face 56 engages the exposed end 40 of the sleeve 18.

In a modification of the dental cutting tool 50, the rod 51B has graduated indicia (not shown) which facilitate determination of the length of the cutting tool. In a further modification, rod 51B is externally threaded (not shown), and depth stop 54 is threaded to threadably move over rod 51B.

In more detail, FIG. 3 illustrates the component parts of the tool 10 in a disassembled state. The threaded rod 14 of the handle 13 has a first portion 14A which is threaded and which is engaged by the barrel 12C of the mirror portion 12. A second portion 14B of the rod 14 is of a diameter less than that of portion 14A. This enables a number of circumferential measuring rings 28 to be formed on the outer surface of portion 14B. These rings 28 form a Vernier scale which, with a graduated scale 44 formed on an outer surface of the sleeve 18 described below, facilitates precise determination of the distance between face 56 and point 52 of cutting tool 50. FIG. 4 illustrates the end 30 of rod 14. A recess 32 2 mm deep is formed in an end face 31 of end 30. This recess 32 forms the floor of the well or socket 48 and locates the point 52 of the tool 50 inserted in the well 48.

The end 36 of sleeve 18 is internally threaded so as to engage threaded portion 14A of rod 14. A portion of the wall of sleeve 18 is removed in a milling process, to form a window 58 through which the rod 14 is viewed. This enables the depth of the well 48 to be determined by measuring the position of the end face 31 of rod 14, using scale 44 and rings 28. Additionally, a portion of the outer surface of sleeve 18 is knurled to provide a finger grip for gripping tool 10, and for rotating sleeve 18 around rod 14.

A locking nut 16 is internally threaded so as to engage first portion 14A of rod 14. The nut 16 is externally knurled to facilitate rotation of the nut around rod 14, and has an annular face 60 which functions as an abutment surface to engage an end face 41 of sleeve 18. This secures the sleeve 18 in a desired position on rod 14.

In use, sleeve 18 is rotated about rod 14 by the dental operator, to vary the depth of the well 48. When the well 48 is set to the predetermined depth, the sleeve 18 is secured using locking nut 16. The dental tool 50 is then inserted into well 48, through opening 42 in end face 41 of sleeve 18, illustrated in FIG. 5. The point 52 engages recess 32, and depth stop 54 is slid until face 56 engages end face 41 of sleeve 18. The dental tool 50 is thus set to the predetermined depth of penetration, and can be used in the dental operation by the dental operator. Subsequently used dental tools have their depths of penetration set in a similar way with minimum disruption of the dental operation.

Furthermore, the mirror is available for use in the dental operation, and is thus at hand to be used by the dental operator to determine and set the length of cutting tools throughout the operation.

The skilled reader will immediately understand that alternative embodiments of adjusting the depth of the well or socket are within the scope of the present invention. For example, FIG. 6 illustrates an alternative embodiment of a dentist's hand tool 110 which includes a latch assembly 112, shown in more detail in FIG. 7. Latch assembly 112 comprises a window 126 formed in sleeve 118, a latch spring 120 and a latch 122. The window 126 includes latch recesses 128, spaced at predetermined intervals along the window. The position of recesses 128 corresponds to the desired depth of well 148. Scale 115 formed on an outer surface of sleeve 118 indicates the position of recesses 128, and therefore the depth of well 148, to the dental operator. Latch 122 is urged to engage latch recesses 128 by latch spring 120.

In use, latch 122 is depressed to disengage the engaged recess 128. Rod 114 is unthreaded, and this enables sleeve 118 to slide over rod 114 to an alternative recess 128. Latch 122 is then released and engages the selected alternative recess 128. Sleeve 118 is thus retained in the desired position and this sets the depth of well 148. When latch 122 is disengaged, sleeve 118 is prevented from rotating about rod 114, for example, by a tongue and groove assembly (not shown) between sleeve 118 and rod 114.

FIG. 8 illustrates a further alternative embodiment of a dentist's hand tool 210, which includes a latch assembly 212, shown in more detail in FIG. 9. Latch assembly 212 comprises a latch clip 216 located on sleeve 218 via axle 226 and latch mounts 228. Latch clip 216 has a latch pin 220 which is urged to engage latch recesses 222 in rod 214 by spring 224. The position of recesses 222 corresponds to the desired depth of well 248. Scale 223 formed on an outer surface of sleeve 218 indicates the position of recesses 222, and therefore the depth of well 248, to the dental operator.

In use, latch clip 216 is disengaged from rod 214 by depressing the end 217 of clip 216. This causes pin 220 to disengage the engaged recess 222. Rod 214 is unthreaded, and this enables sleeve 218 to slide over rod 214 to an alternative recess 222. Clip 216 is released and pin 220 engages the selected alternative recess 222. Sleeve 218 is thus retained in the desired position, and this sets the depth of well 248. When latch clip 216 is disengaged, sleeve 218 is prevented from rotating about rod 214, for example, by a tongue and groove assembly (not shown) between sleeve 218 and rod 214.

In a further alternative embodiment of a dentist's hand tool (not shown), the tool comprises a sleeve which engages a rod via a friction fit and is latched by virtue of friction.

1. A dental instrument in the form of a dentist's hand tool having a well or socket of adjustable depth, the width of the well or socket being sufficient to receive a dental cutting tool the length of which is to be determined and set according to the depth of the well or socket.

2. A dental instrument as claimed in claim 1, wherein the dentist's hand tool is a mirror.

3. A dental instrument as claimed in claim 1 or claim 2, wherein the well or socket is formed in a handle of the hand tool.

4. A dental instrument as claimed in claim 3, wherein the handle comprises a rod which is engaged by one end of an elongated sleeve and the well or socket is formed between the end of the rod within the sleeve and the other, open, end of the sleeve.

5. A dental instrument as claimed in claim 4, wherein the sleeve engages the rod via a screw thread arrangement, such that the sleeve rotates around the rod and moves axially with respect to the rod.

6. A dental instrument as claimed in claim 4, wherein the sleeve engages the rod via a friction fit such that the sleeve engages the rod in a sliding engagement.

7. A dental instrument as claimed in claim 4, wherein the sleeve engages the rod in a latching arrangement such that the sleeve has a number of predetermined latching positions on the rod.

8. A dental instrument as claimed in any one of claims 4 to 7, wherein the hand tool further comprises locking means for locking the sleeve in a desired axial position with respect to the rod.

9. A dental instrument as claimed in claim 8, wherein the locking means is a collar which engages the rod and abuts the sleeve to prevent the sleeve from advancing further over the rod.

10. A dental instrument as claimed in any one of claims 4 to 9, wherein the end of the rod has a shallow recess which locates the end of the cutting tool during determination and setting of its length.

11. A dental instrument as claimed in any one of claims 4 to 10, wherein the sleeve has a graduated scale for determining the length of the dental cutting tool inserted in the well and a window through which the cutting tool is viewed.

12. A dental instrument as claimed in claim 11, wherein the scale is provided upon an external surface of the sleeve where it is visible by a user.

13. A dental instrument as claimed in either of claims 11 or 12, wherein the outer surface of the rod visible in the well when the sleeve engages the rod has a Vernier scale thereon to facilitate precise determination of the length of the cutting tool.
